(19) United States
(12) Patent Application Publication
(10) Pub. No.: US 2008/0206709 A1
(43) Pub. Date: Aug. 28, 2008

(54) GINGIVAL SUPPORT SLEEVE

(76) Inventor: William G. Lannan, Santa Barbara, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/038,552

(22) Filed: Feb. 27, 2008

Related U.S. Application Data
(60) Provisional application No. 60/904,072, filed on Feb. 27, 2007.

(51) Int. Cl. A61C 13/10

(52) U.S. Cl. 433/172

(57) ABSTRACT

A sleeve for use as a gingival abutment in the dental industry and methods for using and making the sleeve are disclosed. The sleeve has a sleeve body with a distal end and a proximal end with a sidewall extending therebetween defining a sleeve interior. The sidewall of the sleeve has an exterior surface at least a portion of which substantially corresponds to a natural tooth profile.

### CROSS REFERENCE TO RELATED APPLICATION

This application claims the benefit of, and incorporates by reference in its entirety, U.S. Provisional Application No. 60/904,072, filed Feb. 27, 2007.

### BACKGROUND OF THE INVENTION

1. Field of the Invention

The present invention is directed to an anatomically-shaped sleeve for use as a gingival abutment in the dental industry and methods for using and making the sleeve.

2. Description of the Related Art

There have been some significant changes in the world of implant dentistry since Dr. Branemark discovered Osseo integration nearly 50 years ago. One of the most significant changes has been the immediate extraction of a tooth with an immediate placement of an implant in the dental bone socket of a patient at the extraction site. Soon after this concept was found to be successful, several clinicians began to place interim restorations onto the immediately placed implants to allow for partial, immediate loading of the implant.

One of the problems encountered in this approach was the establishment of an emergence profile of the implant-supported restoration that supported the gingival tissue to give it a natural appearance. One of the reasons for this problem was that the manufactured healing abutments placed on the implant were cylindrical in shape rather than being the size and shape of the root of the tooth that was extracted. In order to fabricate an interim restoration that would have the correct anatomic root shape, the clinician was required to spend a significant amount of time building the root form from scratch for each implant-supported restoration.

There are several companies that are marketing their ability to fashion implant abutments using a CAD/CAM system. The abutments are milled out of titanium or zirconium. This is a very new application that has yet to prove itself. It does show strong promise if design and logistical problems are worked out.

One CAD/CAM program will create a pre-operative surgical stent for optimal placement of the implant. Using the same scan, it is possible to generate an implant abutment to be placed at the time of surgery. This approach requires a CT scan of the jaws.

Also available is a bar code system marked on the top of their manufactured healing abutments that are placed at the time of surgery. That coding selects the proper milling program for their CAD/CAM milling program so that the custom abutment has the proper height, anatomic shape and orientation to the head of the recently placed implant. The custom abutment can be manufactured and delivered to the clinician in about a week depending on the workload of the milling machine. After delivery, it can then be screwed onto the implant.

Another method available is to scan the model taken at surgery and use a library of root shapes to select the best root shape for the given situation. The turn around time is three weeks.

All three of these methods use a program that mills the root form into a generic cylindrical shape that resembles a megaphone with the smaller end engaging the implant. However, gingival height is maintained best with an abutment that has the proper anatomic shape of a root rather than one that is cylindrical or cone shaped.

Timing is of the essence for all immediately placed implant abutments. The implant is screwed into the bone with a force of greater than 30 Newton/cm. It is not advisable to unscrew a healing abutment after 24 hours for fear of unscrewing the implant from the bone. Any system that introduces a milled abutment at any time other than at surgery introduces a significant level of risk of implant failure.

There are potential problems with the CT scan generated systems. There are several variables that will affect the outcome. The most important one is the ability of the surgeon to accurately place the pre-surgery, CT generated, surgical guide. It is imperative that the surgical guide accurately reflect the anatomy at the time of surgery and that the guide is placed perfectly. Unfortunately, the teeth on which the guide may rest often are mobile at the time of surgery or are in a slightly different place than they were at the time of the CT scan. If the implant is placed optimally with the proper orientation for the pre-placement machined abutment, all is well. If the implant is placed too deeply or not deeply enough or slightly rotated, the milled abutment will not meet the requirements of the situation and becomes problematic.

There is a considerable expense involved with each of the three systems, with the CT scan being the most expensive.

Radiation exposure is also a concern with the CT scanning method. Its use may be limited to extensive treatment scenarios to avoid excessive radiation for the patient. Further, the CT scanning equipment is not universally available and has a significant cost to obtain it. Likewise, there are a limited number of milling machines capable of producing the abutments. This can extend the treatment time frame significantly.

Any adjustments to the milled abutments are extremely difficult due to the physical nature of the titanium and the zirconium. The best results are obtained by milling or laser cutting both of these materials. Unfortunately, both materials are sensitive to the skill of the graphic designer and the computer program, neither of which may be able to deliver the exact design desired by the clinician.

Thus, it is an object of the present invention to provide a gingival support sleeve for use as an implant supported abutment that establishes a natural emergence profile and supports the gingival tissue in a practical and cost-effective manner under the direct control of the clinician.

### SUMMARY OF THE INVENTION

Generally, the present invention is a sleeve for providing gingival support. The sleeve has a sleeve body having a distal end and a proximal end with a sidewall extending therebetween defining an interior. The sidewall of the sleeve body has an exterior surface at least a portion of which substantially corresponds to a natural tooth profile.

In one non-limiting embodiment, the sleeve body is manufactured from a resin material, such as a composite resin material or an acrylic resin material. In another embodiment, the circumference of the exterior surface of the sleeve body adjacent the proximal end is greater than the circumference of the exterior surface of the sleeve body adjacent the distal end. In another embodiment, the sleeve body is tapered from the proximal end to the distal end. Further, the sleeve body may be tapered at an angle of from 5 degrees to 10 degrees or more depending on the desired emergence profile given the depth of placement of a dental implant body. In one embodiment, the distal end of the sleeve body defines an opening and the proximal end of the sleeve body defines an opening aligned with the opening of the distal end. In another non-limiting embodiment, the sleeve interior of the sleeve body is adapted to at least partially receive a dental implant chimney therein. Further, the sleeve body may be at least partially rotatable about a portion of the dental implant chimney. In another embodiment, the dental implant chimney has a distal end and a proximal end with a sidewall extending therebetween defining a dental implant chimney interior. Further, the distal end of the dental implant chimney may be adapted to engage a receiving socket at a proximal end of a dental implant body. Additionally, the distal end of the dental implant body is integrated with a dental bone socket of a patient.

In another embodiment of the present invention, a method of providing gingival support during an implant procedure is provided. The method has the steps of: securing a distal end of a dental implant body into a dental bone socket of a patient; engaging a distal end of a dental implant chimney with a receiving socket of a dental implant body at a proximal end of the dental implant body; placing a sleeve body having a distal end and a proximal end with a sidewall extending therebetween defining a sleeve interior over the dental implant chimney so that the interior of the sleeve body at least partially receives the dental implant chimney therein; and affixing the sleeve body in a desired orientation about the dental implant chimney, wherein an exterior surface of at least a portion of the sleeve body substantially corresponds to a natural tooth profile.

In another embodiment of the aforementioned method, the dental implant chimney defines an interior passageway and further has the step of inserting a securing member through the interior passageway of the dental implant chimney and at least partially within the receiving socket at the proximal end of the dental implant body. Further, the securing member may be one of a screw or a guide pin. In one embodiment of the aforementioned method, the sleeve body is at least partially rotatable about a portion of the dental implant chimney before affixation. In another embodiment of the aforementioned method, a circumference of the exterior surface of the sleeve body adjacent the proximal end is greater than a circumference of the exterior surface of the sleeve body adjacent the distal end.

In a further embodiment of the present invention, a method of providing a gingival support sleeve is provided. The method has the steps of: selecting a natural tooth that corresponds to an average tooth size of a specific tooth type; creating a passageway extending from a distal end of the natural tooth to a proximal end of the natural tooth; securing a distal end of a dental implant body in a container with a proximal end of the dental implant body exposed; inserting a distal end of a securing member through the passageway of the natural tooth and at least partially into a receiving socket at the proximal end of the dental implant body; providing a dental impression material at least partially around an exterior surface of the natural tooth; removing the securing member and the natural tooth from the container after the dental impression material has substantially hardened, thereby forming a recess within the dental impression material in the shape of the natural tooth; securing a cylinder to the exposed proximal end of the dental implant body; providing a resin material within the recess and at least partially around an exterior surface of the cylinder; and after the resin material has substantially hardened, removing the cylinder and a sleeve formed by the hardened resin material, wherein an exterior profile of the sleeve substantially matches the shape of the natural tooth.

In one embodiment, the aforementioned method further has the step of detaching the sleeve from the cylinder. Further, the steps of shaping and polishing the sleeve as desired may be provided. In a further embodiment of the aforementioned method, the composite material is a composite resin or an acrylic resin material.

### BRIEF DESCRIPTION OF THE DRAWINGS

FIG. 1 is a front plan view of a gingival support sleeve in accordance with the present invention;

FIG. 2 is a perspective view of the sleeve of FIG. 1;

FIG. 3 is an exploded perspective view of a first sub-assembly of the present invention having a dental implant body, dental implant chimney, securing member and the sleeve of FIG. 1;

FIG. 4 is a front sectional view of the first sub-assembly of FIG. 3 in assembled form;

FIG. 5 is a cross-sectional view of the assembled sub-assembly of FIG. 4;

FIG. 6 is an exploded perspective view of a second sub-assembly of the present invention having a dental implant body, dental implant chimney, elongated securing member and the sleeve of FIG. 1;

FIG. 7 is a front sectional view of the second sub-assembly of FIG. 6;

FIG. 8 is a cross-sectional view of the assembled sub-assembly of FIG. 7;

FIG. 9 is a top plan view of a non-engaging receiving socket of an implant body;

FIG. 10 is a top plan view of an engaging receiving socket of an implant body;

FIG. 11 is a schematic view of the first sub-assembly of FIG. 3 in assembled form placed in a dental bone socket of a patient;

FIG. 12 is a schematic front view of the securing member, dental implant chimney and sleeve of the first sub-assembly of FIG. 11 being removed from the patient, with the dental implant body remaining in place;

FIG. 13 is a schematic view of the second sub-assembly of FIG. 6 in assembled form placed in the dental bone socket of a patient;

FIG. 14 is a schematic view of an impression material being placed over the second sub-assembly of FIG. 13;

FIG. 15 is a schematic view of the impression material and the dental implant chimney, elongated securing member and sleeve of the second sub-assembly of FIG. 13 being removed from the patient, with the dental implant body remaining in place;

FIG. 16 is a schematic view of the first sub-assembly of FIG. 11 with the securing member, dental implant chimney and sleeve placed on the dental implant body, with composite resin material placed over the sleeve;

FIG. 17 is a partial, cross-sectional front view of a container containing a dental implant body with a natural tooth being secured to the dental implant body via an elongated securing member and with an impression material surrounding the exterior surface of the natural tooth;

FIG. 18 is a schematic view of the container of FIG. 17 with the elongated securing member and natural tooth removed from the container, resulting in a void in the impression material;

FIG. 19 is a schematic view of the container of FIG. 17 with a cylinder secured to the dental implant body via an elongated securing member with composite resin surrounding the exterior surface of the cylinder;

FIG. 20 is a schematic view of the container of FIG. 17 with the cylinder, elongated securing member and resultant sleeve removed from the container;

FIG. 21 is a top plan view of the dental implant chimney of FIG. 1;

FIG. 22 is a perspective view of the dental implant chimney of FIG. 1;

FIG. 23 is a top plan view of the cylinder of FIG. 19; and

FIG. 24 is a perspective view of the cylinder of FIG. 19.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific components illustrated in the attached drawings, and described in the following specification, are simply exemplary embodiments of the invention. Hence, specific dimensions and other physical characteristics related to the embodiments disclosed herein are not to be considered as limiting.

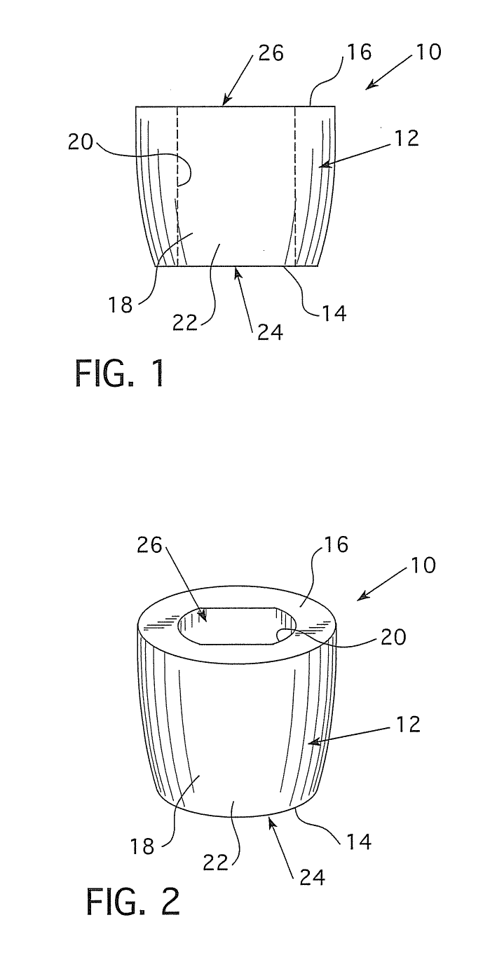

To better illustrate the present invention, FIGS. 1 and 2 show a sleeve 10 for providing gingival support. The sleeve 10 has a sleeve body 12 with a distal end 14 and a proximal end 16. A sidewall 18 extends between the distal end 14 and the proximal end 16, thereby defining a sleeve interior 20. The sidewall 18 has an exterior surface 22 at least a portion of which substantially corresponds to a natural tooth profile for a given tooth, such as an incisor, canine, premolar or molar tooth that the sleeve body 12 is meant to replicate. Each tooth in the mouth has a unique shape to its root structure thereby creating its unique profile. As an example, the maxillary (upper jaw) central incisor most often has an ovoid cross-sectional profile with the oval having a flatter curvature on its labial side and a more pointed curvature on its lingual aspect. The maxillary cuspid has a cross-sectional profile that is often symmetrically ovoid with the labial and lingual curvatures of the elipse nearly equal. Additionally, the cross sectional area of the cuspid is significantly larger than that of the maxillary central incisor. In one non-limiting embodiment, the sleeve body 12 is made from a composite resin or an acrylic resin material. However, the sleeve body 12 can also be made from metal although there are no compelling reasons to do so because of the expense involved with the milling procedures. The most common materials for fabrication are composite resins and acrylic resins that are in common use in the dental office. Other plastics are currently on the horizon and show considerable promise. However, these materials require an industrial injection molding process. Further, the circumference of the exterior surface 22 of the sleeve body 12 adjacent the proximal end 16 is greater than a circumference of the exterior surface 22 of the sleeve body 12 adjacent the distal end 14. Further, the sleeve body 12 is tapered from the proximal end 16 to the distal end 14 at an angle of from 5 degrees to 10 degrees or more depending on the desired emergence profile given the depth of placement of a dental implant body 30. The distal end 14 of the sleeve body 12 defines an opening 24 and the proximal end 16 of the sleeve body 12 defines an opening 26 aligned with the opening 24 of the distal end 14. As will be appreciated by those skilled in the art, the sleeve 10 of the present invention will vary in diameter and shape depending on the tooth that is to be replaced with the implant. Further, it is highly likely that no sleeve 10 is perfectly cylindrical because that root form is a rarity in human tooth form. Further, in one preferred embodiment, the sleeve 10 is approximately 6 mm in height from distal end 14 to the proximal end 16 to allow for any necessary modifications. However, if there is a time when a lesser or greater height is necessary, removals from or additions to the sleeve body 12 are easily made with the use of a compatible dental restorative material.

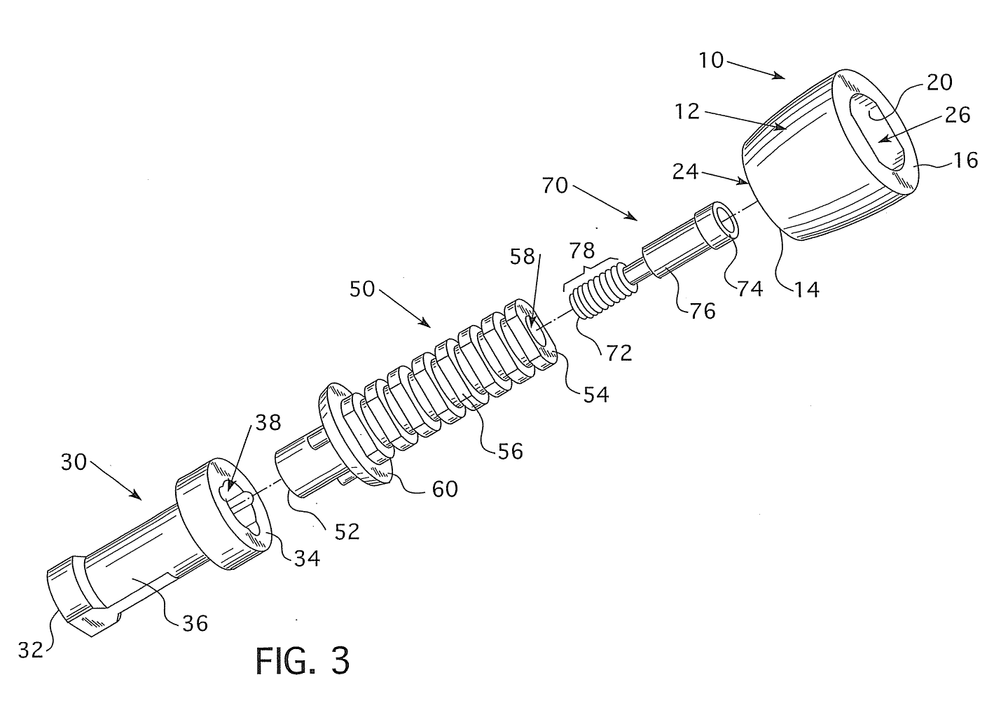

FIGS. 3-5 illustrate a first sub-assembly of the present invention having a dental implant body 30, a dental implant chimney 50, a securing member 70 and the sleeve 10. The dental implant body 30 has a distal end 32 and a proximal end 34 with a shaft 36 extending therebetween. The dental implant body 30 also has a receiving socket 38 at the proximal end 34 of the dental implant body 30. The dental implant body 30 is generally made exclusively of titanium, the surface of which is treated differently by different implant manufacturers according to their views of the osseointegration process. However, the dental implant body 30 may be made of any other suitable material now known or heretofore developed in the art. There are several hundred implant manufacturers worldwide due to the popularity and success of dental implants. The most commonly used components in North America are commercially available from manufacturers such as Nobelbiocare, Neoss, 3i, Straumann and Astra, among others. The present invention is adaptable to most implant systems. The dental implant chimney 50 has a distal end 52 and a proximal end 54 with a sidewall 56 extending therebetween defining a dental implant chimney interior passageway 58. The dental implant chimney 50 is preferably made of titanium or injection molded plastic depending on the operator's preference and the commercially available manufactured parts of the implant system being used. The securing member 70 has a distal end 72 and a proximal end 74 with a shaft 76 extending therebetween. The securing member 70 has an engaging portion 78 at the distal end 72 of the securing member 70. The securing member is preferably made of titanium or other suitable material now known or heretofore developed in the art. As shown in FIGS. 3-5 (and subsequent figures herein), the securing member 70 is in the form of a screw with a threaded engaging portion 78. However, it will be readily appreciated by one of ordinary skill in the art that the securing member 70 may be in the form of other securing means now known or heretofore developed in the art.

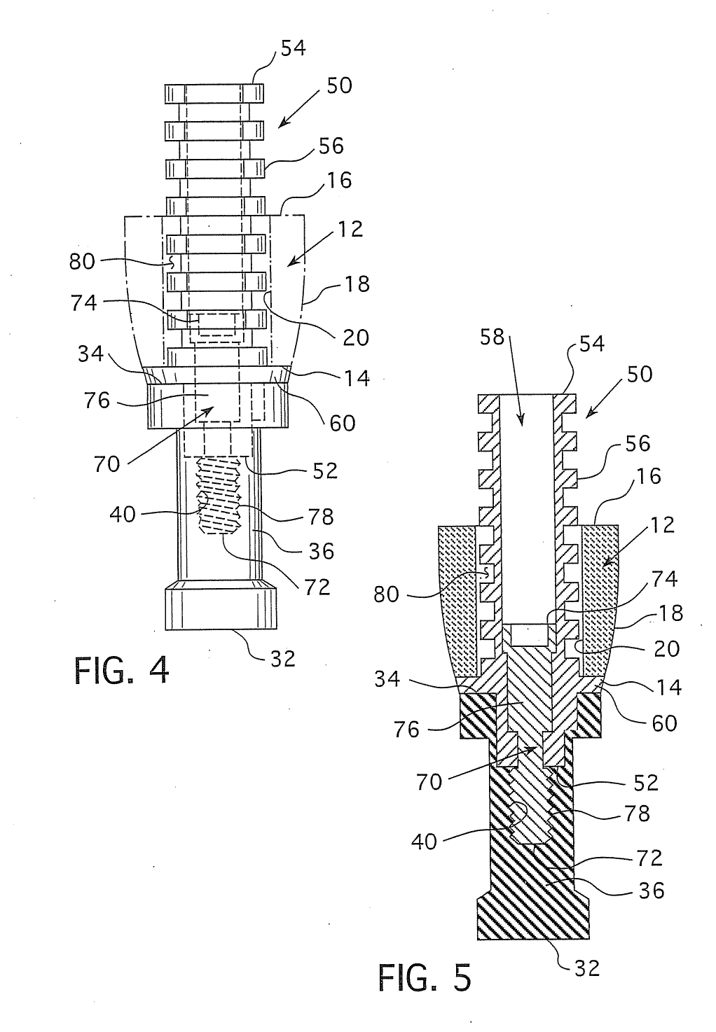

To assemble the first sub-assembly of the present invention, the distal end 52 of the dental implant chimney 50 is placed into the receiving socket 38 at the proximal end 34 of the dental implant body 30. The distal end 52 of the dental implant chimney is adapted to engage the receiving socket 38 at the proximal end 34 of the dental implant body 30. The securing member 70 is placed through the dental implant chimney interior passageway 58 distal end 72 first until it is also placed into the receiving socket 38 at the proximal end 34 of the dental implant body 30 and engaged therein via interaction with the engaging portion 78 and a complimentary interior surface portion 40 contained within the receiving socket 38. The sleeve interior 20 of the sleeve body 12 is adapted to at least partially receive the dental implant chimney 50 therein and, as such, the sleeve body 12 is placed over the dental implant chimney 50 distal end 14 first through the distal end opening 24 and out through the proximal end opening 26 until the distal end 14 of the sleeve body 12 rests on a lip 60 of the dental implant chimney 50. As shown in at least FIGS. 4-5, a gap 80 is present around and between the sidewall 56 of the dental implant chimney and the length of the interior 20 of the sleeve body 12, allowing the sleeve body 12 to be at least partially rotatable about a portion of the dental implant chimney 50. The available sleeve body 12 rotation allows a clinician to rotate the sleeve body 12 into a desired orientation around the dental implant chimney 50 before injecting an affixation material, such as dental cement, into the gap 80 to secure the sleeve body 12 into its desired orientation. Further, as will be readily appreciated by one of ordinary skill in the art and as discussed with later figures, the distal end 32 of the dental implant body 30 may be secured into the dental bone socket 110 of a patient or on a model of a patient during, before or after any of the aforementioned assembly steps. Further, the assembly steps are not meant to be limited in order of performance as one of ordinary skill in the art would recognize that many variations in order of performance are available. Additionally, some or all of the assembly steps may be performed on a patient directly, on a model only or on a mixture of the two in order to minimize patient discomfort.

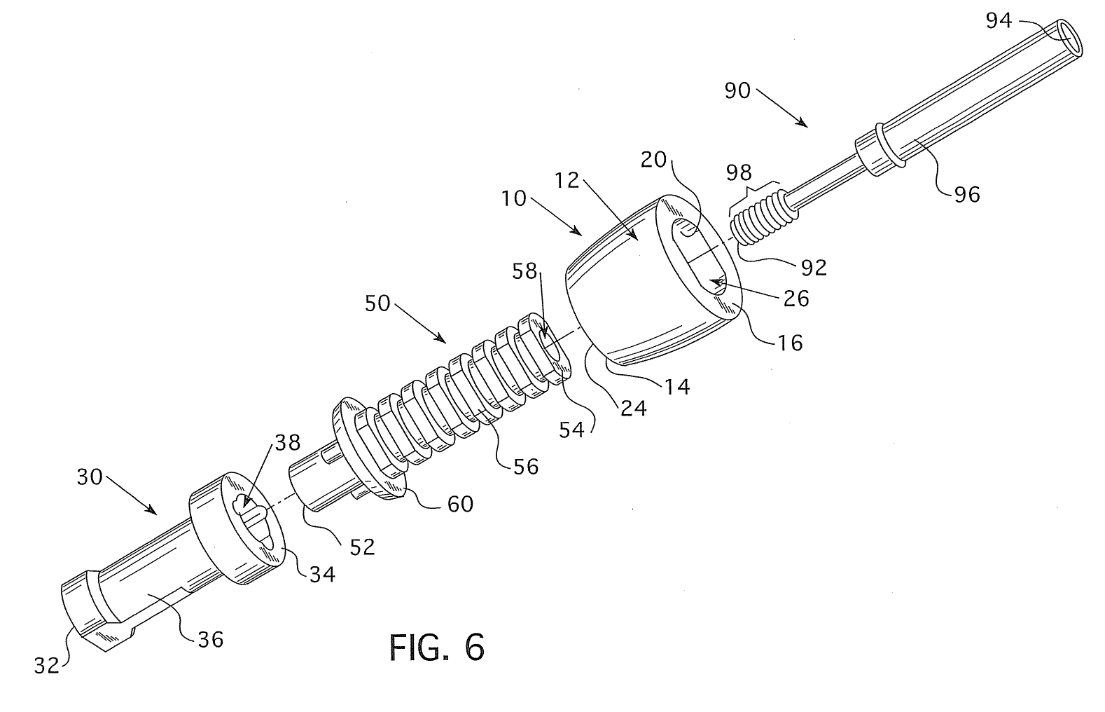

FIGS. 6-8 illustrate a second sub-assembly of the present invention having a dental implant body 30, dental implant chimney 50, an elongated securing member 90 and the sleeve 10. As discussed in reference to the first sub-assembly of the present invention, the dental implant body 30 has a distal end 32 and a proximal end 34 with a shaft 36 extending therebetween. The dental implant body 30 also has a receiving socket 38 at the proximal end 34 of the dental implant body 30. The dental implant chimney 50 has a distal end 52 and a proximal end 54 with a sidewall 56 extending therebetween defining a dental implant chimney interior passageway 58. In the second sub-assembly of the present invention, however, an elongated securing member 90 is preferred. The elongated securing member 90 has a distal end 92 and a proximal end 94 with a shaft 96 extending therebetween. The elongated securing member 90 also has an engaging portion 98 at the distal end 92 of the securing member 90. The elongated securing member is preferably made of titanium or any other suitable material now known or heretofore developed in the art. As shown in FIGS. 6-8 (and subsequent figures herein), the elongated securing member 90 is in the form of a guide pin with threaded engaging portion 98. However, it will be readily appreciated by one of ordinary skill in the art that the elongated securing member 90 may be in the form of other securing means now known or heretofore developed in the art.

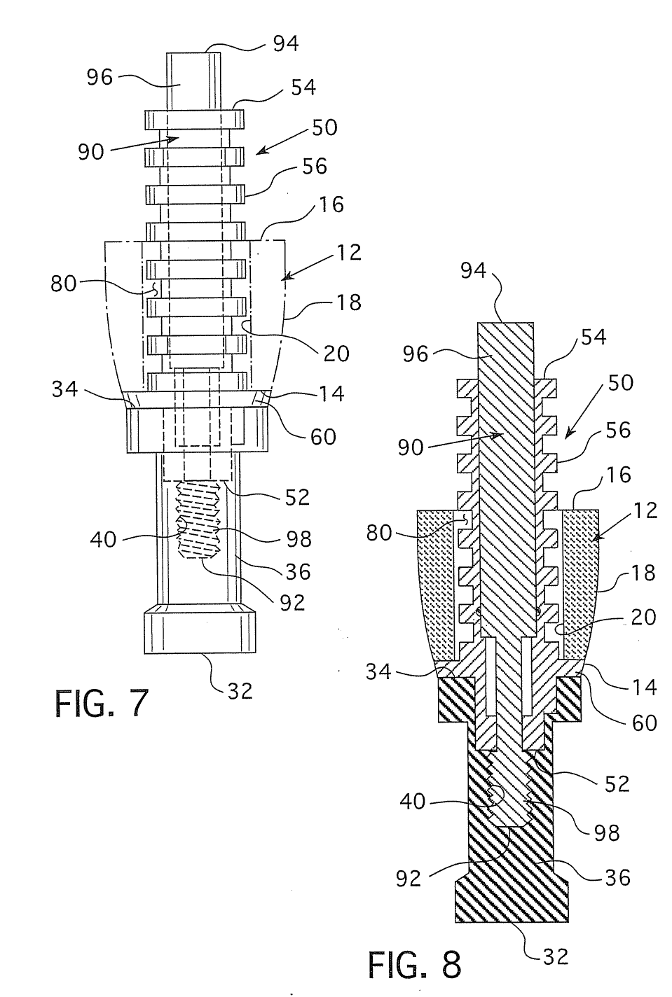

To assemble the second sub-assembly of the present invention, the distal end 52 of the dental implant chimney 50 is placed into the receiving socket 38 at the proximal end 34 of the dental implant body 30. The distal end 52 of the dental implant chimney is adapted to engage the receiving socket 38 at the proximal end 34 of the dental implant body 30. The elongated securing member 90 is placed through the dental implant chimney interior passageway 58 distal end 92 first until it is also placed into the receiving socket 38 at the proximal end 34 of the dental implant body 30 and engaged therein via interaction with the engaging portion 98 and a complimentary interior surface portion 40 contained within the receiving socket 38. The sleeve interior 20 of the sleeve body 12 is adapted to at least partially receive the dental implant chimney 50 therein and, as such, the sleeve body 12 is placed over the dental implant chimney 50 distal end 14 first through the distal end opening 24 and out through the proximal end opening 26 until the distal end 14 of the sleeve body 12 rests on a lip 60 of the dental implant chimney 50. As shown in at least FIGS. 7-8, a gap 80 is present around and between the sidewall 56 of the dental implant chimney 50 and the length of the interior 20 of the sleeve body 12, allowing the sleeve body 12 to be at least partially rotatable about a portion of the dental implant chimney 50. The available sleeve body 12 rotation allows a clinician to rotate the sleeve body 12 into a desired orientation around the dental implant chimney 50 before injecting an affixation material, such as dental cement, into the gap 80 to secure the sleeve body 12 into its desired orientation. Finally, as shown in FIGS. 7 and 8, the length of the shaft 96 of the elongated securing member 90 allows the proximal end 94 of the elongated securing member to extend outside of the proximal end 54 of the dental implant chimney 50. Further, as will be readily appreciated by one of ordinary skill in the art, the distal end 32 of the dental implant body 30 may be secured into the dental bone socket of a patient or on a model of a patient during, before or after any of the aforementioned assembly steps. Further, the assembly steps are not meant to be limited in order of performance as one of ordinary skill in the art would recognize that many variations in order of performance are available. Additionally, some or all of the assembly steps may be performed on a patient directly, on a model only or on a mixture of the two in order to minimize patient discomfort.

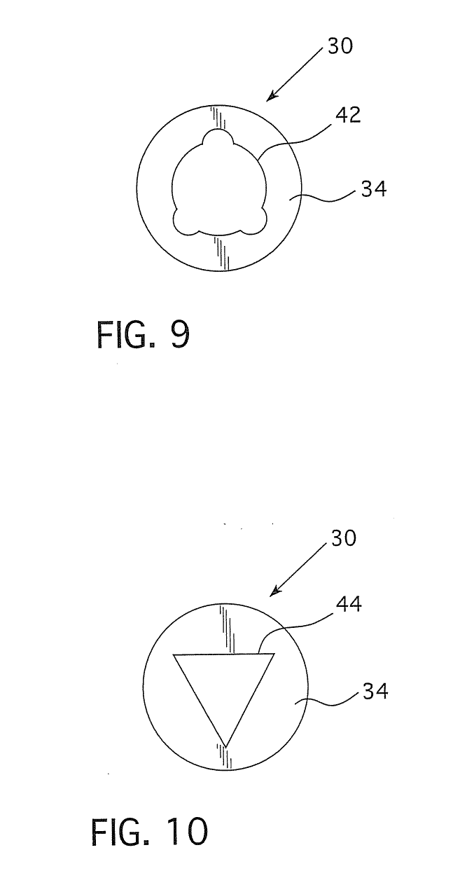

As shown in FIGS. 9 and 10, the proximal end 34 of the dental implant body 30 may take the form of a variety of sizes and shapes and the corresponding distal end 52 of the dental implant chimney 50 will match the size and shape of the its corresponding proximal end 34 distal implant body 30. FIG. 9 is a representative illustration of a proximal end 34 of a dental implant body 30 having a non-engaging profile 42 of a receiving socket 38. FIG. 10 is a representative illustration of a proximal end 34 of a dental implant body 30 having an engaging profile 44 of the receiving socket 38. Numerous dental implant body 30 and corresponding dental implant chimney 50 sets are commercially available, such as those made by the manufacturers previously noted. There are two main styles of connection. The original concept was that of an external connection where there is a hexagonal head milled onto the head of the dental implant body 30 at the proximal end 34 onto which an implant fixture, such as the distal end 52 of the dental implant chimney 50, is fastened. More recently, there has been a move toward the internal connection concept where there is a three to eight sided well milled into the head of the dental implant body 30 at the proximal end 34 into which an abutment fixture is fastened, such as the distal end 52 of the dental implant chimney 50. It will be readily appreciated by one of ordinary skill in the art that any of such dental implant body 30 and corresponding dental implant chimney 50 sets currently available or heretofore developed may be used with the gingival support sleeve 10 of the present invention. Further, it will be readily appreciated by one of ordinary skill in the art that that any of such dental implant body 30 and corresponding dental implant chimney 50 sets currently available or heretofore developed may be used with the first sub-assembly or the second sub-assembly of the present invention and that the dental implant body 30 and dental implant chimney 50 shown and discussed herein are for illustrative purposes only and not meant to limit the scope of the present invention.

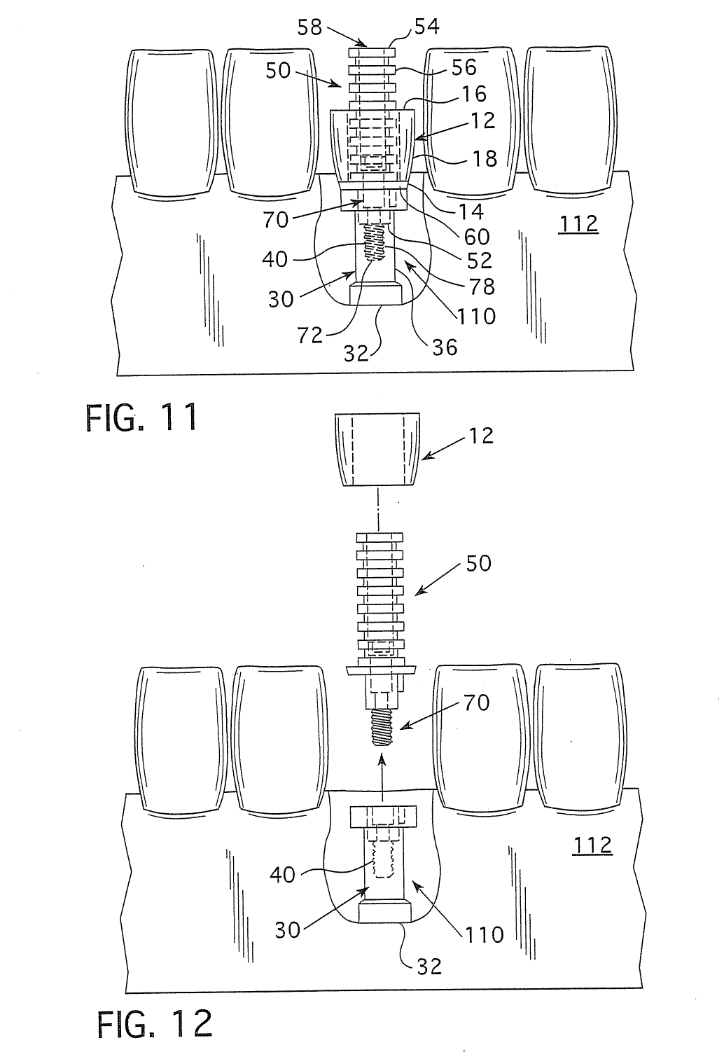

FIGS. 11-16 illustrate a method of providing gingival support during an implant procedure using the gingival support sleeve 10 of the present invention. As shown in FIG. 11 and using the first sub-assembly of the present invention, the method involves the following steps: securing the distal end 32 of the dental implant body 30 into a dental bone socket 110 of a patient after an affected tooth has been removed or displaced; engaging the distal end 52 of the dental implant chimney 50 with the receiving socket 38 of the dental implant body 30 at the proximal end 34 of the dental implant body 30; placing the sleeve body 12 having a distal end 14 and a proximal end 16 with a sidewall 18 extending therebetween defining a sleeve interior 20 over the dental implant chimney 50 so that the interior 20 of the sleeve body 12 at least partially receives the dental implant chimney 50 therein; and affixing the sleeve body 12 in a desired orientation about the dental implant chimney 50, wherein an exterior surface 22 of at least a portion of the sleeve body 12 substantially corresponds to a natural tooth profile. The dental implant chimney 50 has a dental implant interior passageway 58 and the method further has the step of inserting a securing member 70 through the interior passageway 58 of the dental implant chimney 50 and at least partially within the receiving socket 38 at the proximal end 34 of the dental implant body 30. As discussed above, the securing member 70 may be in the form of a screw or securing alternatives thereto. Further, an elongated securing member 90 may be used in the form of a guide pin or securing alternatives thereto. The sleeve body 12 is at least partially rotatable about a portion of the dental implant chimney 50 before affixation. Further, a circumference of the exterior surface 22 of the sleeve body 12 adjacent the proximal end 16 is greater than a circumference of the exterior surface of the sleeve body 12 adjacent the distal end 14.

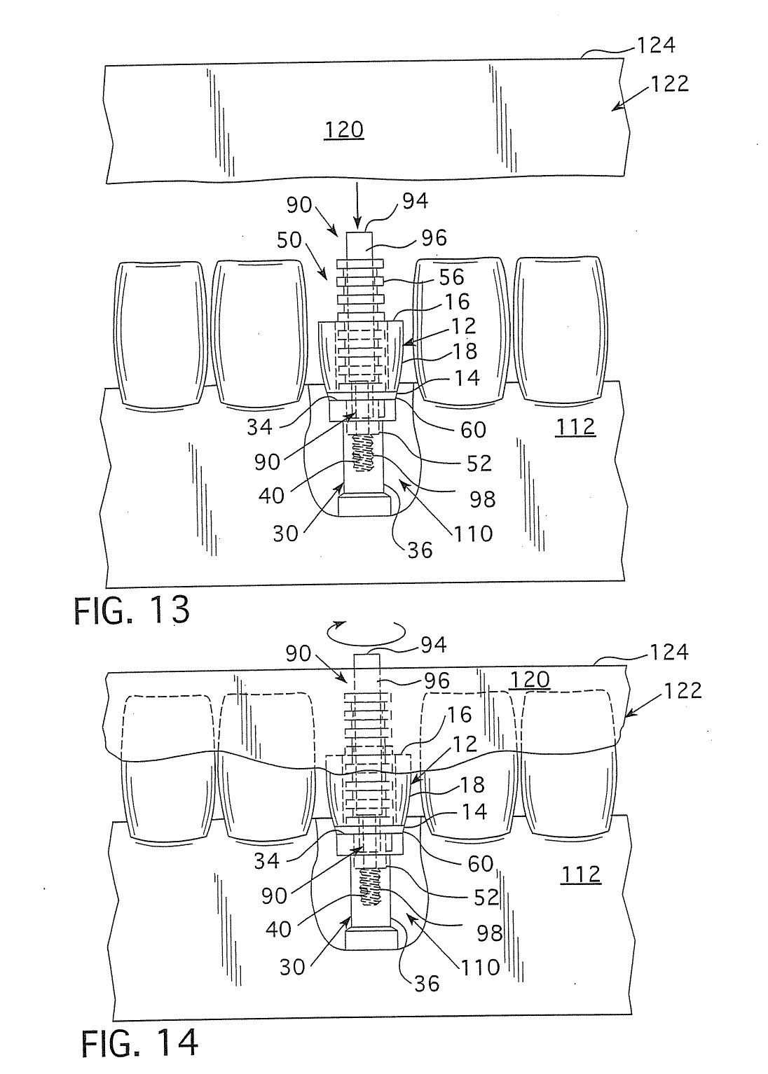

In practice, and at the time of surgery, the first sub-assembly of FIG. 11 is placed into the bone socket 110 of a patient in order to support gingival tissue 112 of a patient. The first sub-assembly may remain in the patient for a period of from three to six months until the dental implant body 30 is integrated into the bone socket 110 of the patient. As shown in FIG. 12, if an immediate fixed transitional crown is to be placed onto the dental implant body 30, the sleeve body 12, the dental implant chimney 50 and the securing member 70 are removed from the patient. At this time, and as shown in FIG. 13, the second sub-assembly of the present invention is placed onto the dental implant body 30 within the dental bone socket 110 of the patient.

As discussed previously, the second sub-assembly is assembled similar to the first sub-assembly; however, the second sub-assembly uses an elongated securing member 90 in lieu of the securing member 70. Essentially, the distal end 52 of the dental implant chimney 50 is placed into the receiving socket 38 at the proximal end 34 of the dental implant body 30. The distal end 52 of the dental implant chimney 50 is adapted to engage the receiving socket 38 at the proximal end 34 of the dental implant body 30. The elongated securing member 90 is placed through the dental implant chimney interior passageway 58 distal end 92 first until it is also placed into the receiving socket 38 at the proximal end 34 of the dental implant body 30 and engaged therein via interaction with the engaging portion 98 and a complimentary interior surface portion 40 contained within the receiving socket 38. The sleeve interior 20 of the sleeve body 12 is adapted to at least partially receive the dental implant chimney 50 therein and, as such, the sleeve body 12 is placed over the dental implant chimney 50 distal end 14 first through the distal end opening 24 and out through the proximal end opening 26 until the distal end 14 of the sleeve body 12 rests on the lip 60 of the dental implant chimney 50. As discussed above, the length of the shaft 96 of the elongated securing member 90 allows the proximal end 94 of the elongated securing member to extend outside of the proximal end 54 of the dental implant chimney 50.

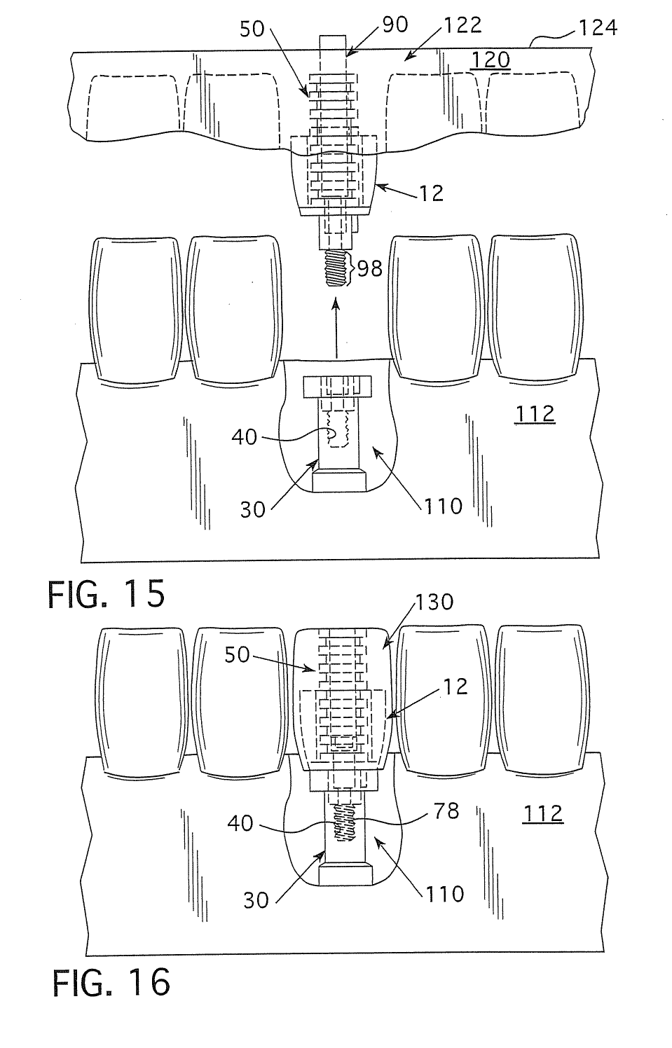

As shown in FIG. 14, an open tray impression is made using standard practice dental impression material in an impression tray 122. Due to the length of the elongated securing member 90, the proximal end 94 of the elongated securing member 90 protrudes through a proximal tray surface 124. When the impression is set, the engaging portion 98 of the elongated securing member 90 is un-mated from the complimentary interior surface portion 40 of the dental implant body 30. As shown in FIG. 15, the elongated securing member 90, the dental implant chimney 50 and the sleeve body 12 removed in the impression tray when they are removed from the patient. Next, the first sub-assembly of the present invention is then reattached to the proximal end 34 of the dental implant body 30 to prevent the gingival tissue 112 from collapsing, while a crown 130 is created on a model produced from the impression. The crown 130 is fabricated in the laboratory with the sleeve body 12 removed in the impression forming the base of the crown 130. As shown in FIG. 16, when the crown 130 is completed, the first sub-assembly of the present invention is removed, and the crown 130 is secured to the dental implant body 30 with the securing member 70.

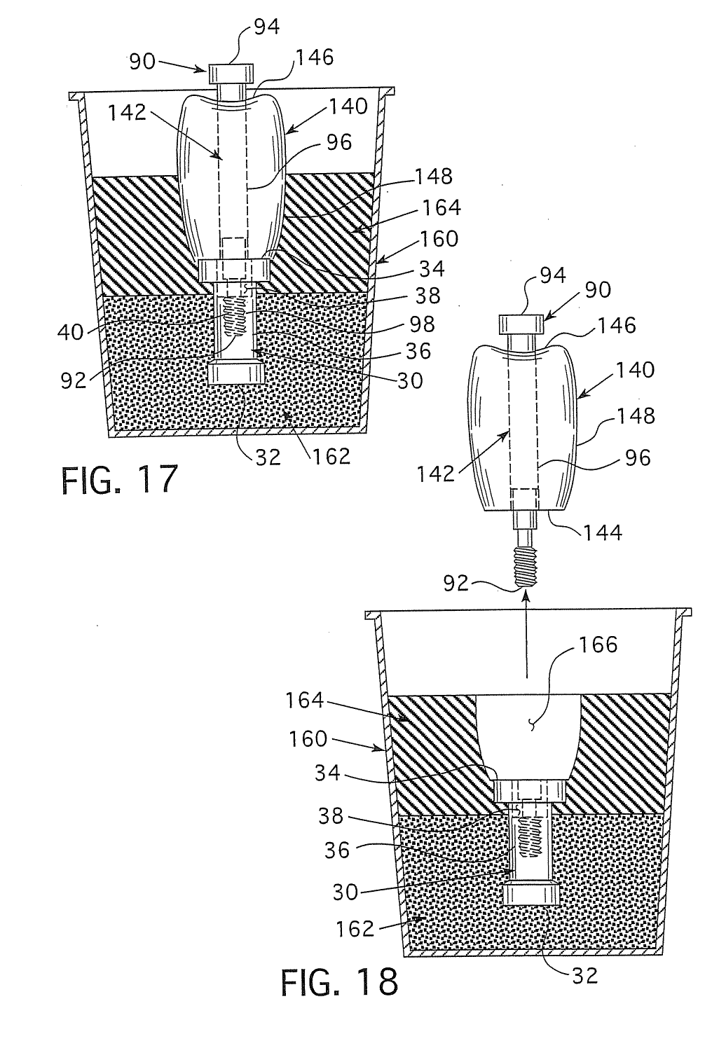

FIGS. 17-20 illustrate a method of providing a gingival support sleeve 10 according to the present invention. The method has the steps of: selecting a natural tooth 140 that corresponds to a mean tooth size of a specific tooth type; creating a passageway 142 extending from a distal end 144 of the natural tooth to a proximal end 146 of the natural tooth 140; securing a distal end 32 of a dental implant body 30 in a securing material 162, such as cement, in a container 160 with a proximal end 34 of the dental implant body 30 exposed; inserting a distal end 92 of an elongated securing member 90 through the passageway 142 of the natural tooth 140 and at least partially into a receiving socket 38 at the proximal end 34 of the dental implant body 30; providing a dental impression material 164 at least partially around an exterior surface 148 of the natural tooth 140; removing the elongated securing member 90 and the natural tooth 140 from the container 160 after the dental impression material 164 has substantially hardened, thereby forming a recess 166 within the dental impression material 164 in the shape of the natural tooth 140; securing a cylinder 170 to the exposed proximal end 34 of the dental implant body 30; providing a resin material 168 within the recess 166 and at least partially around an exterior surface 172 of the cylinder 170; and, after the resin material 168 has substantially hardened, removing the cylinder 170 and a sleeve 10 formed by the hardened resin material 168, wherein an exterior surface 22 profile of the sleeve 10 substantially matches the shape of the natural tooth 140.

As shown in FIG. 17, a container 160 is provided and the distal end 32 and shaft 36 of the dental implant body 30 are secured in the container 160 via securing material 162, such as, but not limited to, cement or dental stone. As will be readily appreciated by one of ordinary skill in the art, any now known or heretofore developed securing material 162 or alternative securing means may be used. A natural tooth 140 having a distal end 144 and a proximal end 146 with a passageway 142 created therebetween is placed distal end 144 first onto the proximal end 34 of the dental implant body 30. The passageway 142 is created by means of a drill or other passageway-creating techniques now known or heretofore developed. Further, the distal end 144 of the natural tooth 140 is preferably cut off at the place where the cross-sectional area of the natural tooth 140 would closely match the cross-sectional area of the proximal end 34 of the dental implant body 30. An elongated securing member 90 having a distal end 92 and proximal end 94 with a shaft 96 therebetween is placed through the passageway 142 of the natural tooth 140 distal end 92 first and into the receiving socket 38 of the dental implant body 30. The engaging portion 98 of the elongated securing member 90 engages a complimentary interior surface portion 40 contained within the receiving socket 38. If needed, resin material, such as composite resin material, may be placed around at least a portion of the exterior surface 148 of the natural tooth 140 so that the distal end 144 of the natural tooth 140 approximately corresponds to the size and/or shape of the proximal end 34 of the distal implant body 30. A dental impression material 164 is then placed at least partially around the exterior surface 148 of the natural tooth 140. The dental impression material 164 is preferably a clear vinyl polysiloxane dental impression material so that light cured composite resins can be used. An opaque impression material 164 will not allow enough light from a curing light source to penetrate and thereby set off the chemical reaction that causes the resin material to harden. Any available impression material 164, such as a poly ether or one that is rubber or silicon based, is acceptable if the material to be used for the invention is chemically cured, such as is the case with an acrylic resin.

As shown in FIG. 18, after the dental impression material 164 has hardened, the elongated securing member 90 and the natural tooth 140 are removed from the container 160 after the dental impression material 164 has substantially hardened, creating a recess 166 in the shape of the natural tooth 140 in the dental impression material 164.

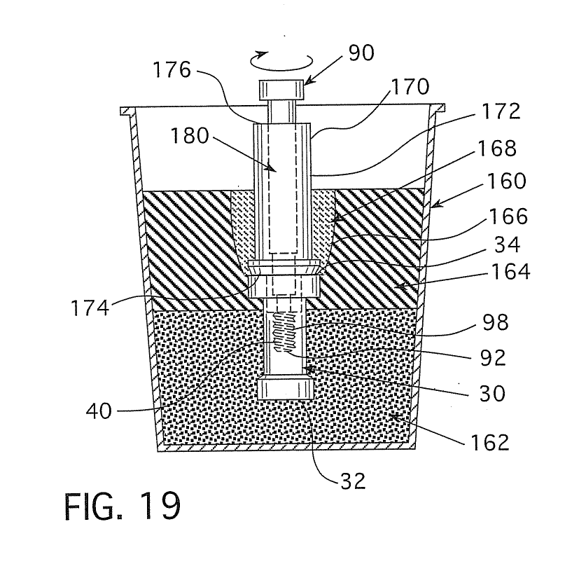

As shown in FIG. 19, a cylinder 170 having a distal end 174 and a proximal end 176 and a sidewall 178 extending therebetween defining an interior passageway 180 is provided. The cylinder 170 is for manufacturing purposes only and can be made from any durable material such as a metal or plastic, as long as the sidewall 178 surface remains smooth and the cylindrical form remains constant throughout multiple uses over time. Aluminum is preferred, however, for its ease of machining and its durability. The distal end 174 of the cylinder 170 is mated to the proximal end 34 of the dental implant body 30. An elongated securing member 90 having a distal end 92 and proximal end 94 with a shaft 96 therebetween is placed through the interior passageway 180 of the cylinder 170 distal end 92 first and into the receiving socket 38 of the dental implant body 30. The engaging portion 98 of the elongated securing member 90 engages a complimentary interior surface portion 40 contained within the receiving socket 38. A resin material 168 (such as a composite resin or an acrylic resin material) is then placed within the recess 166 and at least partially around an exterior surface 172 of the cylinder 170.

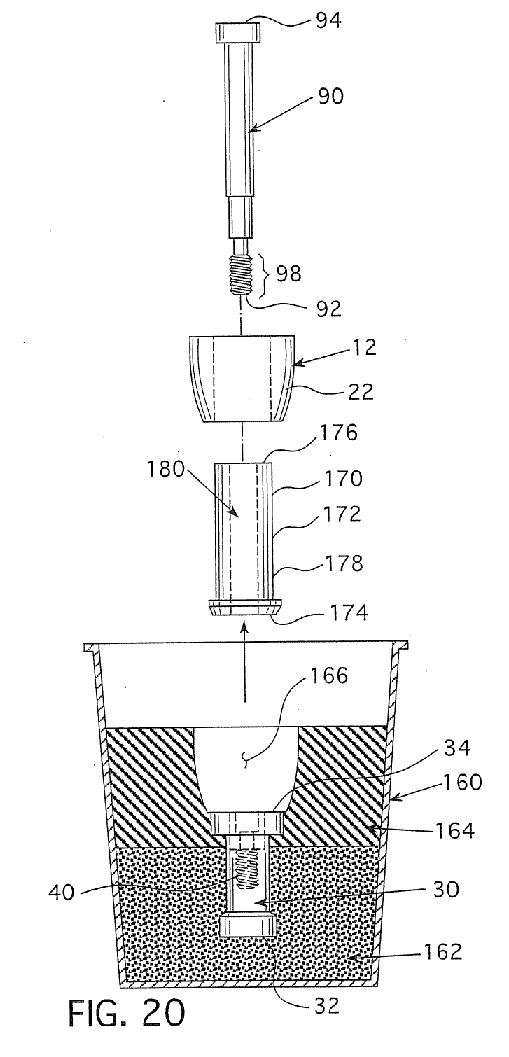

After the resin material 168 has substantially hardened, and as shown in FIGS. 19 and 20, the cylinder 170 is loosened as the engaging portion 98 of the elongated securing member 90 is un-mated from the complimentary interior surface portion 40 of the dental implant body 30. As shown in FIG. 20, the cylinder 170, elongated securing member 90 and sleeve 10 formed by the hardened resin material 168 are removed from the container 160 and detached from one another. Detaching the sleeve 10 from the cylinder 170 is easier if the exterior surface 172 of the cylinder 170 is lubricated prior to placing the resin material 168 in the recess 166. Once the aforementioned steps are performed, the exterior surface 22 profile of the sleeve 10 substantially matches the shape of the natural tooth 140. However, the sleeve 10 may be shaped and polished as desired.

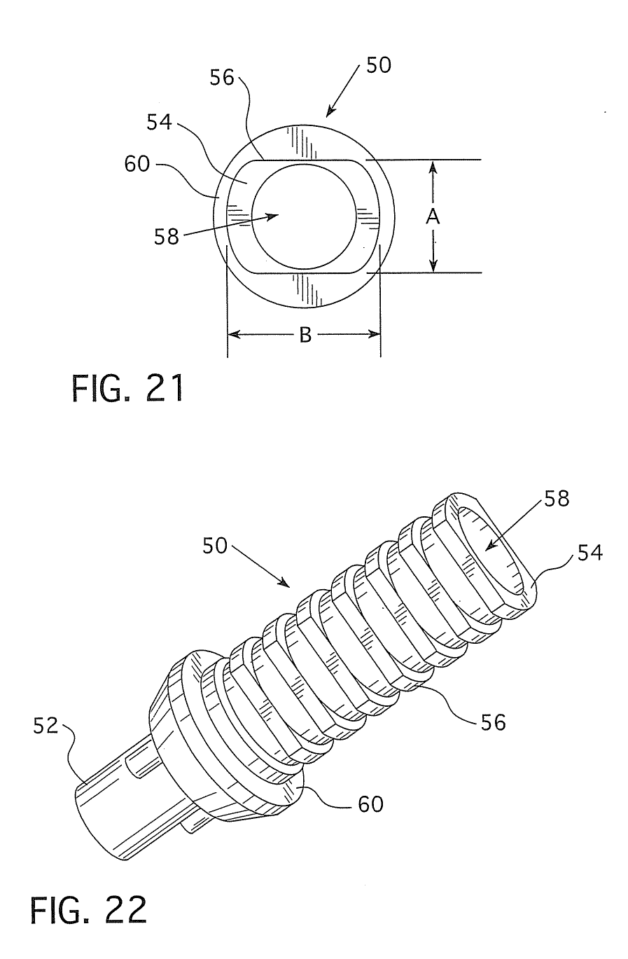

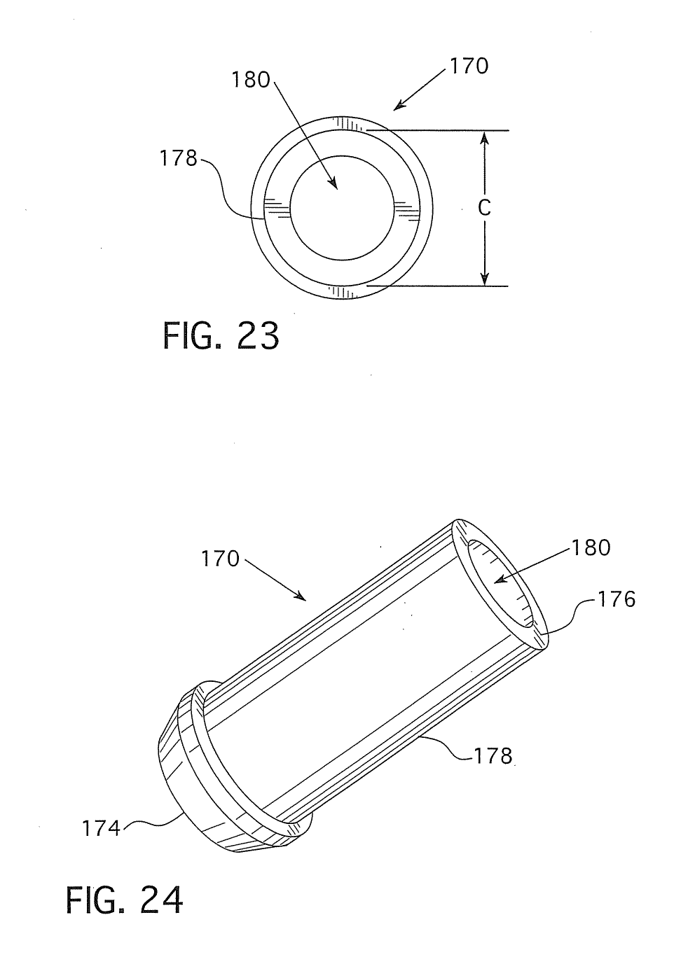

FIGS. 21-24 provide a comparison between the dental implant chimney 50 and the cylinder 170 of the present invention and illustrate the importance of using the cylinder 170 when manufacturing the sleeve 10 of the present invention. As shown in FIGS. 21-22, the dental implant chimney 50 has a distal end 52 and a proximal end 54 with a sidewall 56 extending therebetween and an interior passageway 58. As shown in FIGS. 23-24, the cylinder 170 used to manufacture the sleeve 10 of the present invention also has a distal end 174 and a proximal end 176 with a sidewall 178 extending therebetween and an interior passageway 180. However, the distance represented by A or B at FIG. 21 showing the proximal end 54 of the dental implant chimney 50 is less than the distance represented by C at FIG. 23 showing the proximal end 176 of the cylinder 170. The greater distance represented by C provides for the sleeve interior 20 to be wider than the distance represented by A or B, and as such, allows the sleeve body 12 to be rotatable about a portion of the dental implant chimney 50 before affixation to the sleeve interior 20 in a dental procedure.

The natural tooth 140 used as the pattern for the sleeve 10 of the present invention was first selected from the study of a series of extracted natural teeth as the representative size of a bicuspid tooth and a common tooth to be replaced with the immediate extraction/immediate implant placement/immediate temporization technique for which the present invention has its greatest application. This bicuspid tooth best represented the average size and shape for a given patient population and was used as the natural tooth 140. This selection procedure is then done for each natural tooth 140 located in the mouth from the first molar to the first molar on both upper and lower jaws. The initial study was completed using a minimum of three teeth for comparison to a maximum of ten teeth for each tooth location. Small, medium and large teeth for each tooth location may also be impressed and added to the selection of molds. Further, the natural tooth 140 can be matched to narrow, regular and wide dental implant bodies 30. Generally, the average or mean-sized natural tooth 140 in each category can than be matched to the proximal end 34 of the dental implant body 30.

Depending upon the material selected by the clinician for the fabrication of the transitional restoration, the sleeve 10 of the present invention can be made of either a composite resin or an acrylic resin, or any other suitable material now known or heretofore developed. The sleeve 10 is a versatile tool for both the surgeon and the restoring dentist that solves the gingival support problem. The root form sleeve 10 is exactly or nearly identical to the shape of the root of a natural tooth 140. As described herein, this is accomplished by the fact that each sleeve 10 is specific for each natural tooth 140 being replaced and is fabricated from a mold of an actual tooth of representative size.

The use of the sleeve 10 dramatically decreases the time necessary to fabricate an interim restoration following implant placement. The anatomically correct root form of the sleeve 10 maintains gingival height and contour better than a cylindrical-shaped root form. Further, because sleeve 10 for a given tooth is an identical root form, the gingival tissue keeps its contour throughout the restorative process.

With the present invention, the implant team is able to keep the entire procedure close at hand and in house so that they are able to produce an anatomically correct interim restoration and/or healing abutment in a minimum amount of time.

Further, sleeve 10 is a very cost-effective solution to soft tissue management during an implant-supported restoration in an esthetically sensitive area. The sleeve 10 is also easily adaptable to any space and size requirements with the addition of commonly available dental materials. It is also able to be trimmed to a smaller size if the space available for the implant requires it.

The use of the present invention saves a clinician valuable time in the establishment of an optimal root form. When the sleeve 10 is used in patient care following the extraction and immediate placement of an implant, the fabrication of an interim restoration can be accomplished in approximately half an hour or less.

Because the sleeve 10 is of uniform shape and size, its use throughout the treatment phase maintains support for, and the shape of, the gingival tissues. This is very important for the comfort of the patient during the taking of impressions.

Further, the patient population for use with the present invention is generally mammalian, such as, humans. However, it will be readily appreciated by one of ordinary skill in the art that the present invention can also be used with a variety of life forms.

In summary, the beneficial features of the root form sleeve 10 are related to its ability to be rotated freely about the dental implant chimney 50. This allows the clinician to properly orient the sleeve 10 before securing it to the dental implant chimney 50 that is engaged with the proximal end 34 of the dental implant body 30. Also, this enables the sleeve 10 and the dental implant chimney 50 to have multiple functions. It may function first as healing abutment at the time of surgery. Second, it may function as the root form of an interim crown restoration. Third, it may function as an impression coping. All three functions are able to be accomplished quickly and in a cost-effective manner as described above.

The present invention has been described with reference to the preferred embodiments. Modifications, combinations and alterations will occur to others upon reading the preceding detailed description. It is intended that the invention be construed as including all such modifications, combinations and alterations.

The invention claimed is:

1. A sleeve for providing gingival support, comprising a sleeve body having a distal end and a proximal end with a sidewall extending therebetween defining a sleeve interior, said sidewall having an exterior surface at least a portion of which substantially corresponds to a natural tooth profile.

2. The sleeve of claim 1, wherein the sleeve body comprises a resin material.

3. The sleeve of claim 1, wherein a circumference of the exterior surface of the sleeve body adjacent the proximal end is greater than a circumference of the exterior surface of the sleeve body adjacent the distal end.

4. The sleeve of claim 3, wherein the sleeve body is tapered from the proximal end to the distal end.

5. The sleeve of claim 4, wherein the sleeve body is tapered at an angle of from 5 to 10 degrees.

6. The sleeve of claim 1, wherein the distal end of the sleeve body defines an opening and the proximal end of the sleeve body defines an opening aligned with the opening of the distal end.

7. The sleeve of claim 1, wherein the sleeve interior of the sleeve body is adapted to at least partially receive a dental implant chimney therein.

8. The sleeve of claim 7, wherein the sleeve body is at least partially rotatable about a portion of the dental implant chimney.

9. The sleeve of claim 7, wherein the dental implant chimney has a distal end and a proximal end with a sidewall extending therebetween defining a dental implant chimney interior.

10. The sleeve of claim 9, wherein the distal end of the dental implant chimney is adapted to engage a receiving socket at a proximal end of the dental implant body.

11. The sleeve of claim 10, wherein the distal end of the dental implant body is secured into a dental bone socket of a patient.

12. A method of providing gingival support during an implant procedure, comprising the steps of:
securing a distal end of a dental implant body into a dental bone socket of a patient;
engaging a distal end of a dental implant chimney with a receiving socket of the dental implant body at a proximal end of the dental implant body;
placing a sleeve body having a distal end and a proximal end with a sidewall extending therebetween defining a sleeve interior over the dental implant chimney so that the interior of the sleeve body at least partially receives the dental implant chimney therein; and
affixing the sleeve body in a desired orientation about the dental implant chimney, wherein an exterior surface of at least a portion of the sleeve body substantially corresponds to a natural tooth profile.

13. The method of claim 12, wherein the dental implant chimney defines an interior passageway and further comprising the step of inserting a securing member through the interior passageway of the dental implant chimney and at least partially within the receiving socket at the proximal end of the dental implant body.

14. The method of claim 13, wherein the securing member is one of a screw or a guide pin.

15. The method of claim 12, wherein the sleeve body is at least partially rotatable about a portion of the dental implant chimney before affixation.

16. The method of claim 12, wherein a circumference of the exterior surface of the sleeve body adjacent the proximal end is greater than a circumference of the exterior surface of the sleeve body adjacent the distal end.

17. A method of providing a gingival support sleeve, comprising the steps of:
selecting a natural tooth that corresponds to an average tooth size of a specific tooth type;
creating a passageway extending from a distal end of the natural tooth to a proximal end of the natural tooth;
securing a distal end of a dental implant body in a container with a proximal end of the dental implant body exposed;
inserting a distal end of a securing member through the passageway of the natural tooth and at least partially into a receiving socket at the proximal end of the dental implant body;
providing a dental impression material at least partially around an exterior surface of the natural tooth;
removing the securing member and the natural tooth from the container after the dental impression material has substantially hardened, thereby forming a recess within the dental impression material in the shape of the natural tooth;
securing a cylinder to the exposed proximal end of the dental implant body;
providing a resin material within the recess and at least partially around an exterior surface of the cylinder; and
after the resin material has substantially hardened, removing the cylinder and a sleeve formed by the hardened resin material, wherein an exterior profile of the sleeve substantially matches the shape of the natural tooth.

18. The method of claim 17, further comprising the step of detaching the sleeve from the cylinder.

19. The method of claim 18, further comprising the steps of shaping and polishing the sleeve as desired.

20. The method of claim 17, wherein the resin material is a composite resin material or an acrylic resin material.
